(19) United States
(12) Patent Application Publication
(10) Pub. No.: US 2026/0078782 A1
(43) Pub. Date: Mar. 19, 2026

(54) POSITIONER AND METHOD FOR MANUFACTURING A POSITIONER

(71) Applicant: Samson Aktiengesellschaft, Frankfurt am Main (DE)

(72) Inventors: Christof Weigand, Oberursel (DE); Matthias Grasz, Grossostheim (DE); Nikolai Schulz, Eppertshausen (DE)

(73) Assignee: Samson Aktiengesellschaft, Frankfurt am Main (DE)

(21) Appl. No.: 19/109,055

(22) PCT Filed: Sep. 4, 2023
(86) PCT No.: PCT/EP2023/074156

§ 371 Date: Mar. 5, 2025

(30) Foreign Application Priority Data
Sep. 6, 2022 (DE) 10 2022 122 565.8

(51) Int. Cl. F15B 20/00; F15B 13/04

(52) U.S. Cl. CPC F15B 20/00; F15B 13/0401

(57) ABSTRACT

A positioner for a pneumatic actuator for operating a control element, such as a control valve, in a process engineering system, is described. The positioner may include an electropneumatic converter, such as a current-to-pressure converter, a circuit board comprising supply electronics for operating the electropneumatic converter, and a housing surrounding an interior space. A support body that may be inserted into the interior space is may be provided, to which the circuit board may be attached. The housing and the carrier are coordinated with each other to pneumatically subdivide the interior space into an electronics compartment for accommodating at least one electrical and/or electronic component, such as the supply electronics, and a converter compartment for accommodating the electro-pneumatic converter.

### CROSS REFERENCE TO RELATED APPLICATIONS

This patent application is a United States national stage application of International Application No. PCT/EP2023/074156, filed Sep. 4, 2023, which claims priority to German Patent Application No. 10 2022 122 565.8, filed Sep. 6, 2022, each of which is incorporated herein by reference in its entirety.

### BACKGROUND

The disclosure relates to a positioner for a pneumatic actuator for operating a control element, such as a control valve in a process engineering plant, such as a chemical plant, particularly a petrochemical plant, a power plant, a brewery, or the like. The disclosure also relates to a method for manufacturing such a positioner.

EP 0 587 170 B1 describes an electropneumatic signal converter that is modular and explosion-proof. A current-to-pressure converter is arranged in a hollow housing section, which has a pneumatic supply connection and a pneumatic output for controlling an actuator. The housing also includes a box section with electrical contacts housed therein. Electrical, pneumatic, and electropneumatic components are housed in the housing. The housing has an electronics housing module for the electrical components and a pressure housing module for the pneumatic and electropneumatic components that can be screwed into it. The electronics housing module is separated from the pressure housing module by a module wall, through which conductors are led in an explosion-proof manner to contact the electropneumatic components. A pressure sensor is also arranged in the electronics housing module. The common arrangement of the current-to-pressure converter and pneumatic components, all of which generate exhaust air, in the same chamber makes precise monitoring and control difficult.

In the case of improper use of electropneumatic positioners, there is a risk that dirt introduced into the housing chamber can lead to deposits on the positioner electronics and electropneumatics. Dirt deposits can cause damage or malfunctions, for example, through short circuits of electrical contacts. It has been shown that the introduction of dirt, for example, due to damage or contamination of the pneumatic pressure supply, or the use of a lower-quality pneumatic pressure supply, is to be expected.

When an explosive and/or flammable gas, such as natural gas, is to be used as the pneumatic medium, there is also the requirement that leakage of the flammable gas at the positioner is not allowed. The flammable pneumatic medium must be discharged through a collection line. Such flammable gases can also be corrosive and lead to damage to electronic components. It is also conceivable that ignition could occur due to electrical currents.

In conventional positioners, circuit boards are provided for the various electronic components, which are arranged spaced apart from the current-to-pressure converter and individually encapsulated in different spaces. This results in a high space requirement. It also requires a large number of feedthroughs with correspondingly high manufacturing and assembly effort and leakage risk.

### BRIEF DESCRIPTION OF THE DRAWINGS/FIGURES

The accompanying drawings illustrate the embodiments of the present disclosure and, together with the description, further serve to explain the principles of the embodiments and to enable a person skilled in the pertinent art to make and use the embodiments.

FIG. 1 shows a cross-sectional view of a positioner according to an exemplary embodiment of the disclosure.

FIG. 2 shows a cross-sectional view of a positioner with a potting compound encapsulating the circuit board, according to an exemplary embodiment of the disclosure.

FIG. 3 shows another cross-sectional view of the positioner according to FIG. 2.

FIG. 4 shows a top view into the interior space of the positioner according to FIG. 2.

FIG. 5 shows a top view into the interior space of the positioner according to FIG. 4 without the support body and circuit board.

FIG. 6 shows a perspective detail view of a support plate from a first direction. FIG. 7 shows a perspective detailed view of the support plate according to FIG. 6 from a second direction.

FIG. 8 shows a sectional view through the support plate with the circuit board attached.

FIG. 9 shows a perspective detail view of the circuit board.

FIG. 10 shows a detailed view of a cover part for covering a ventilation channel from the electronics compartment through the housing of an inventive positioner.

FIG. 11 shows a sectional view through the cover part with through-holes and the ventilation channel according to FIG. 10.

FIG. 12 shows a detailed view of the cover part.

FIG. 13 shows a view of the housing of the positioner according to FIG. 10 from below.

FIG. 14 shows a detailed view of an alternative cover part with groove channels.

FIG. 15 shows a cross-sectional view of the positioner according to FIG. 10.

FIG. 16 shows a schematic representation of a positioner according to an exemplary embodiment of the disclosure.

The exemplary embodiments of the present disclosure will be described with reference to the accompanying drawings. Elements, features and components that are identical, functionally identical and have the same effect are-insofar as is not stated otherwise respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the disclosure is to provide a positioner that overcomes the disadvantages of conventional techniques, which is particularly simple, space-saving, and/or cost-effective to manufacture and/or suitable for the use of a critical pneumatic medium, such as a corrosive, contaminated, explosive, and/or flammable pneumatic medium.

Accordingly, a positioner for a pneumatic actuator for operating a control element, such as a control valve in a process engineering plant, particularly a petrochemical plant, a power plant, a food processing plant, particularly a brewery, or the like, is provided. The positioner may comprise an electropneumatic converter, a circuit board, and a housing.

In an exemplary embodiment, the electropneumatic converter can be realized as a current-to-pressure converter. An electropneumatic converter realizes an electropneumatic component of a positioner. An electropneumatic converter may be designed and arranged to set a converter pressure depending on an electrical signal. In an exemplary embodiment, an electropneumatic converter is designed and arranged to set the converter pressure based on, on the one hand, a pneumatic source that provides a pressurized pneumatic medium, such as ambient air, nitrogen, or the like, at a supply pressure, and on the other hand, a pneumatic sink, such as the atmosphere, which defines a reference pressure, for example, corresponding to the ambient pressure. In an exemplary embodiment, an electropneumatic converter is arranged to set the converter pressure considering an electrical signal, particularly an analog or digital electrical signal, such as a current signal or a voltage signal. For example, the electropneumatic converter can be realized as a current-to-pressure converter and, in particular, set the converter pressure proportionally or at least substantially proportionally to a current signal. The electropneumatic converter may be designed and arranged to provide the converter pressure at an effective input or effective output for at least one other pneumatic component, such as a pneumatic amplifier. In an exemplary embodiment, a pneumatic component refers to a purely pneumatically or mechanically-pneumatically acting component, particularly free of electronics. In other words, it should be clear that within the scope of the present disclosure, a distinction can be made between, on the one hand, purely pneumatic components, on the other hand, purely electronic components, and furthermore, electropneumatic hybrid components. For operation with a flammable pneumatic medium, particularly natural gas, the at least one electronic component, the at least one electropneumatic converter, and/or the possible at least one pneumatic sensor can be operated in an intrinsically safe manner.

The circuit board may comprise supply electronics for the electropneumatic converter. Optionally, the circuit board can comprise control and/or regulation electronics for operating the electropneumatic converter. Alternatively, it is conceivable that the control and/or regulation electronics for the electropneumatic converter are distributed among several electronic components, particularly circuit boards of the positioner, such as including the circuit board. The term circuit board can generally refer to a flat component made of an electrically insulating material, such as a fiber-reinforced plastic material, ceramic material, hard paper, or the like, to which electrical and/or electronic components are attached. Circuit boards can commonly be implemented as so-called printed circuit boards. In particular, the circuit board has conductor tracks on at least one surface, such as on two opposite surfaces. The conductor tracks may be permanently attached to at least one surface of the circuit board, for example, printed or soldered. Additionally or alternatively, the circuit board can be equipped with feedthroughs to electrically connect conductor tracks on a first surface, for example, the top side, with conductor tracks on a second surface, for example, the bottom side. Electrical and/or electronic components, such as microchips, microprocessors, resistors, capacitors, diodes, contacts, connectors, or the like, can be attached to at least one surface of the circuit board, such as under electrical contact with conductor tracks, for example, glued, clamped, screwed, and/or soldered. A circuit board generally has a flat shape, with the planar outline adapted to the housing receiving the circuit board, for example, semicircular. The circuit board may have a width dimension and a length dimension that are substantially the same order of magnitude or whose dimensions differ by no more than a hundredfold, particularly no more than a tenfold. The circuit board has a thickness dimension that is significantly smaller than the width dimension and the length dimension of the circuit board, with its dimension being, for example, at least ten times, particularly at least a hundred times, smaller. Feedthroughs or the like extend through the circuit board in the thickness dimension.

The housing surrounds an interior space. In an exemplary embodiment, the housing consists of at least two shell parts detachably connected to each other, through which the interior space is fully enclosed. The shell parts forming the housing can, for example, be realized as a pot-shaped base body with at least one opening and a detachable cover that completely closes the opening in an operationally mounted state. The housing can be designed and arranged for the dust-and/or water-protected accommodation of electrical, electronic, electropneumatic, pneumatic, and other components. The housing may be designed such that the interior space is formed as a pressure-sealed space. The housing can, for example, be designed according to protection class IP65 or better. A housing for the dust-and/or water-protected accommodation of electrical components can, for example, be defined according to a protection class of the so-called International Protection Code (IP Code). Protection classes can describe the degree of protection of the housing against contact, foreign bodies, water, and the like. IP codes can, for example, be specified according to IEC 529, EN 60529, DIN VDE 0470-1 in the respective 2014 version. The first digit of the IP code indicates protection against foreign bodies and contact, with a higher value indicating more pronounced protection. The first digit can have the following meaning: 3: protected against solid foreign bodies larger than 2.5 mm and against contact with tools; 4: protected against solid foreign bodies larger than 1 mm and against contact with wire; 5: protected against dust and contact; 6: dust-tight, protected against contact. The second digit of the IP code concerns protection against water. The second digit can have the following meaning: 3: protected against spraying water; 4: protected against splashing water; 5: protected against jet water; 6: protected against strong jet water or heavy seas; 7: protected against temporary immersion; 8: protected against continuous immersion. The housing can, for example, correspond to at least protection class IP 65, at least IP 66, at least IP 67, at least IP 68, or at least IP 69.

The positioner according to the disclosure may comprise a support body inserted into the interior space. The circuit board is attached to the support body. The support body can, in particular, be formed as a plate, whereby such a support body can be referred to as a carrier plate. The term plate-shaped can refer to a relatively flat body in relation to the volume of the housing. The carrier plate can, for example, have a plate width and a plate length that are significantly larger than the plate height. The plate length and/or the plate width is or are at least 5 times, such as at least 10 times, as large as the plate height. Plate width, plate height, and plate length can generally refer to dimensions of the carrier plate oriented transversely, particularly perpendicularly, to each other. The plate length can be larger than the plate width. The plate length can, for example, be in the range of 1 to 8 times, up to 5 times, or up to 2 times as large as the plate width. The carrier plate can, for example, be circular or ring-shaped, with the circle or ring diameter corresponding to the plate width and length.

The housing and the support body are coordinated to pneumatically subdivide the interior space into an electronics compartment and a converter compartment. The electronics compartment is designed to accommodate at least one electrical and/or electronic component. In particular, the electronics compartment is designed to accommodate the supply electronics. Alternatively or additionally, the electronics compartment can be designed to accommodate control and/or regulation electronics, or the like. The converter compartment is designed to accommodate the electropneumatic converter. For example, the support body can realize a wall part that can be inserted into the interior space to subdivide the interior space into, on the one hand, the electronics compartment and, on the other hand, the converter compartment. In particular, the support body, such as together with the circuit board, forms a room divider for the interior space. In an exemplary embodiment, the support body can be form-fitted to a contour, particularly an inner peripheral contour, in the interior space of the housing. It can be preferred that the support body is at least partially form-fitted to the interior space. For example, the width and/or length of the support body can be matched to a clear width of the interior space. The support body and the housing, particularly the interior space, can, for example, have at least partially complementary cross-sections. In an operationally mounted state of the positioner, the support body spatially and/or pneumatically separates the electronics compartment from the converter compartment. In an operationally mounted state of the positioner, a pressure-tight separation of the housing interior space into, on the one hand, the converter compartment and, on the other hand, the electronics compartment can be realized by the support body. A pressure-tight area or pressure-tight compartment of the positioner can, for example, be designed and arranged to be pressure-tight for an environment with an explosive or flammable atmosphere. For example, different areas in the housing can be separated from each other by the support body to meet the explosion protection requirements “Ex d,” i.e., the ignition protection type of pressure-tight encapsulation “Ex d.” The inventive construction allows for a particularly simple, cost-effective, compact, and reliable positioner. By subdividing the interior space into an electronics compartment and a separate converter compartment, corrosion and/or contamination of electronic components, particularly on the circuit board, can be avoided. The interior space of the housing can be equipped to form a pressure-sealed space with one or more pneumatic and/or pressure-tight separations. In an exemplary embodiment, the converter compartment forms at least one pressure-sealed space. In particular, the electronics compartment forms another pressure-sealed space.

In a preferred embodiment of an inventive positioner, the electropneumatic converter is arranged, particularly attached, on a side of the support body that is facing away from the electronics compartment and/or the circuit board. When the electropneumatic converter is attached to the support body, it can be preferred that the electropneumatic converter is electrically connectable to the circuit board, for example, by means of a plug or the like. In an alternative embodiment of an inventive positioner, the circuit board has a connection point on its surface facing the converter compartment for the detachable attachment of the electropneumatic converter to the circuit board. It can be preferred that the circuit board is arranged on the side of the support body facing the electronics compartment. The connection point can, for example, be realized by a connector, a socket, or the like. In an exemplary embodiment, the electropneumatic converter is arranged, particularly attached, on a side of the circuit board facing away from the electronics compartment.

According to one embodiment of an inventive positioner, the converter compartment may comprise at least one receptacle. The receptacle can also be referred to as a converter receptacle. In the area of the receptacle, the support body defines a feedthrough that extends from the housing to the circuit board. In an exemplary embodiment, the receptacle is at least partially bounded by a bottom, a peripheral wall, and/or another housing wall section of the housing. The peripheral wall refers to the part of the housing that laterally bounds the interior space, including any recesses in the bottom. The receptacle can, for example, be formed by an indentation in the housing, such as a recess in the bottom, or the like. A housing indentation is generally bounded by one or more housing wall sections. It can be preferred that the receptacle is bounded on the one hand by the housing and on the other hand by the support body with the circuit board held thereon. The support body and the circuit board adjoin the receptacle. In an exemplary embodiment, the circuit board at least partially bounds the receptacle. In an exemplary embodiment, the electropneumatic converter is at least partially, particularly fully, arranged within this receptacle. The feedthrough can form part of a chamber that realizes the receptacle. The interior space of the housing can be subdivided into a plurality of sub-areas, wherein a first sub-area or several first sub-areas can be assigned to the converter compartment, and a second sub-area or several second sub-areas can be assigned to the electronics compartment. The different sub-areas can be realized by chambers within the housing. In an exemplary embodiment, a first sub-area of the interior space is realized by the receptacle for the electropneumatic converter. Several first sub-areas can be separated from each other, particularly pneumatically and/or pressure-tight, for example, by housing wall sections. In an exemplary embodiment, the different sub-areas inside the housing form individually pressure-sealed spaces. Individual pressure-sealed spaces are pressure-tight relative to each other. The sub-area assigned to the converter compartment, which accommodates the electropneumatic converter, forms a first individually pressure-sealed space. Several individual sub-areas assigned to the converter compartment, each accommodating at least one or exactly one pneumatic sensor, form several second individually pressure-sealed spaces. An exchange of pneumatic medium into and/or out of a pressure-sealed space may be only possible in an operational state by means of a certain number of predetermined pneumatic lines, such as exactly one pneumatic line, exactly two pneumatic lines, or exactly three pneumatic lines. In an exemplary embodiment, the first pressure-sealed space is equipped with exactly two pneumatic lines, namely the ventilation line and an exhaust channel. In an exemplary embodiment, the second pressure-sealed spaces each have exactly one pneumatic line. The electronics compartment can realize another individually pressure-sealed space, with the electronics compartment being free of or equipped with exactly one pneumatic line, particularly designed as a ventilation line. Optionally, the pneumatic compartment can form an additional individually pressure-sealed space. The number of pneumatic lines with which the pneumatic compartment is equipped can correspond to the sum of the pneumatic lines of the first and second pressure-sealed spaces.

In a preferred embodiment of an inventive positioner, the converter compartment may comprise at least one further receptacle in which at least one pneumatic sensor is arranged. The further receptacle can also be referred to as a sensor receptacle. A pneumatic sensor can, for example, be a pressure sensor, a temperature sensor, a humidity sensor, or the like, or a combination of several or all of the mentioned sensors. The converter compartment can particularly have several receptacles for a plurality of pneumatic sensors. It should be clear that alternatively or additionally, at least one pneumatic sensor can be arranged in the receptacle for the electropneumatic converter. The at least one further receptacle may be at least partially bounded by a bottom, a peripheral wall, and/or another housing wall section of the housing. The at least one further receptacle can, for example, be formed by an indentation in the housing or the like, which can be framed by the bottom and a housing wall section. The support body and the circuit board adjoin the further receptacle. In particular, the support body bounds a further feedthrough in the area of the further receptacle, which leads, particularly from the housing, to the pneumatic sensor and/or to the circuit board. The further feedthrough can lead to a pneumatic sensor arranged, particularly attached, on the circuit board. In an exemplary embodiment, another first sub-area of the interior space is realized by the further receptacle for the pneumatic sensor. Several further first sub-areas can be separated from each other, particularly pneumatically and/or pressure-tight, for example, by housing wall sections. For example, the positioner in the converter compartment can comprise a converter receptacle and several sensor receptacles that are pneumatically and/or pressure-tight separated from each other. It can be preferred that different measurement points are provided in the positioner, and each of the different measurement points is assigned at least one of the several different pneumatic sensors. According to a preferred development, the positioner in the converter compartment may comprise several particularly further receptacles with different pneumatic sensors arranged therein to detect different pressures in the positioner, for example, a pressure of the pneumatic medium at an input and/or output of the electropneumatic converter, a pressure of the pneumatic medium at a supply input of the positioner connected to a pneumatic source, and/or a pressure of the pneumatic medium at an actuator output of the positioner for operating a pneumatic actuator.

In a further development of a positioner with at least one pneumatic sensor, this is arranged on a surface of the circuit board facing the converter compartment. Alternatively or additionally, the pneumatic sensor is held on the circuit board. It can be preferred that the at least one pneumatic sensor is firmly connected to the circuit board, for example, soldered. It can be preferred that control and/or regulation electronics are arranged on the circuit board, particularly on its top side, which are connected for signal transmission by means of conductor tracks and/or feedthroughs or the like to the at least one pneumatic sensor, particularly arranged on the underside of the circuit board. The at least one pneumatic sensor, particularly the several pneumatic sensors, such as all pneumatic sensors of the positioner, are arranged on the surface of the circuit board facing away from the electronics compartment. The circuit board can carry several pneumatic sensors. In an exemplary embodiment, the pneumatic sensor or sensors are electrically connected to the circuit board. In particular, it is conceivable that at least one pneumatic sensor is arranged in one or more of the at least one further receptacle and separated from the circuit board, for example, on a separate circuit board, on the support body, the housing, or the like. In an exemplary embodiment, several different pneumatic sensors are arranged on the same surface of the circuit board facing the converter compartment. It can be preferred that the at least one pneumatic sensor is arranged in the area of the further feedthrough on the circuit board. In a support body, particularly a support plate with several feedthroughs, different pneumatic sensors can be arranged in the respective area of the several feedthroughs. In an exemplary embodiment, at least one pneumatic sensor is arranged in the area of the feedthrough for the electropneumatic converter.

According to one embodiment of an inventive positioner, at least one sealing element, such as a sealing ring, is held on the support body to pneumatically and/or pressure-tight separate the converter compartment, particularly the receptacle (the converter receptacle), and/or the at least one further receptacle (the at least one sensor receptacle) from the electronics compartment. In particular, at least one sealing element, such as a sealing ring, is arranged between the support body and the circuit board. Alternatively or additionally, in particular, at least one sealing element, such as a sealing ring, is arranged between the support body and the housing. In an interior space composed of several chambers, each chamber can be assigned at least one sealing element to pneumatically and/or pressure-tight separate the respective chamber from one or more other chambers. For example, each receptacle and/or further receptacle can be assigned at least one sealing element. It can be preferred that at least one sealing element, such as two sealing elements, particularly one sealing element at the opposite ends of the sides of the feedthrough or feedthroughs, are arranged on a support element at each feedthrough.

According to one embodiment of an inventive positioner, the housing has a peripheral wall and a bottom at least partially surrounded by the peripheral wall with a recess corresponding to the circuit board. In an exemplary embodiment, the circuit board is at least partially or fully insertable into the recess of the housing. In such a positioner, the electronics compartment can be defined in the interior space of the housing above the recess, and the converter compartment can be defined below the support body inserted into the recess. In an embodiment where the converter receptacle and/or possibly the sensor receptacle(s) are partially bounded by a respective feedthrough, essentially only the section of the respective receptacle formed by the feedthrough is arranged in the recess. Adjacent to the recess, an indentation or several indentations can be formed in the housing, with a first indentation being designed to at least partially accommodate the electropneumatic converter and further indentations being designed to at least partially accommodate at least one pneumatic sensor each. The support body is form-fitted to the interior space, particularly the recess. In particular, a clearance is provided between the support body and the housing, particularly the peripheral wall and/or another housing wall section, in the area of the recess. With the help of such a clearance, assembly steps, such as potting the support body within the housing, can be simplified. By flooding the clearance with potting material, a potting structure can be easily formed, which encapsulates the support body in the area of the feedthroughs to form a boundary area that pressure-tight bounds the receptacles. Additionally or alternatively, a cavity is formed between the support body and the circuit board. The cavity is at least partially, for example fully, bounded on the one hand by the circuit board and on the other hand by the support body. According to a further development, the support body may comprise several support sections, such as columns, struts, or the like, for supporting the circuit board. At least one cavity is formed between the several support sections. Optionally, several cavities can even be formed between the several support sections. By potting the cavities between, on the one hand, the support body and, on the other hand, the circuit board and/or housing, the effective sealing can be enhanced.

In a preferred embodiment of the inventive positioner, the circuit board is at least partially encapsulated, particularly with a potting compound. In an exemplary embodiment, the circuit board is encapsulated at least in the area of the supply electronics. The encapsulation can seal or at least substantially seal the supply electronics from the electronics compartment.

Additionally or alternatively, the support body is at least partially encapsulated, particularly with a potting compound. In particular, the encapsulation surrounds the support body in the area of the feedthrough and/or the further feedthrough or further feedthroughs. By encapsulating the support body, a solid wall of sufficient thickness for separating the compartments, for example, when using natural gas in the converter compartment, can be realized. Particularly preferred is an encapsulation, especially with a potting compound, that at least partially surrounds both the support body and the circuit board. A potting compound may be provided on the circuit board and/or the support body, at least in the area of the converter receptacle and/or the at least one sensor receptacle. In an embodiment of a positioner with a clearance between the support body and the housing, it can be provided that the potting compound may completely fill the clearance. Additionally, or alternatively, in another embodiment of a positioner with at least one cavity between the support body and the circuit board, the potting compound can at least partially, such as fully, fill this at least one cavity. The encapsulation, particularly the potting compound, can realize a sealing element. By encapsulating the circuit board and/or the support body, a pressure-tight sealing element for separating the electronics compartment from the converter compartment can be formed. The encapsulation of the circuit board can form a protective layer for the electronic components arranged on the circuit board, such as supply electronics for the electropneumatic converter, and/or control and/or regulation electronics for operating the electropneumatic converter. The encapsulated components are particularly protected against damage, contamination, or corrosion by the pneumatic medium. By potting the spaces between, on the one hand, the support body and/or the circuit board and, on the other hand, the housing, the space around the chambers can be potted, thereby enhancing the effective sealing.

According to one embodiment of an inventive positioner, the supply electronics, and optionally the control and/or regulation electronics, are arranged on a surface of the circuit board facing the electronics compartment. In an exemplary embodiment, the supply electronics, and optionally the control and/or regulation electronics, are arranged on a first, particularly upper, side opposite to a second, particularly lower, side, which includes the surface for the electropneumatic converter and/or the at least one pneumatic sensor.

The disclosure also relates to a method for manufacturing a positioner for a pneumatic actuator for operating a control element, such as a control valve in a process engineering plant. The inventive method may comprise providing a circuit board with supply electronics provided thereon, and optionally control and/or regulation electronics provided thereon, and a provided or detachably connectable electropneumatic converter with the circuit board. Optionally, the provided circuit board can be equipped with at least one pneumatic sensor. Furthermore, the inventive method may comprise providing a particularly pot-shaped housing with an interior space and providing a support body that can be inserted into the housing. The circuit board is then inserted into the interior space. The circuit board, which may be inserted into the interior space, is attached to the housing by means of the support body.

In the inventive method, the interior space is divided by the support body into an electronics compartment that accommodates the supply electronics and a converter compartment that accommodates the electropneumatic converter. The support body can spatially divide the interior space into, on the one hand, the electronics compartment and, on the other hand, the converter compartment. It can be preferred that a pneumatic and/or pressure-tight division of the interior space into an electronics compartment and a converter compartment is realized by means of the support body. In an exemplary embodiment, only purely electrical and/or purely electronic components, such as control and/or regulation electronics, are accommodated in the electronics compartment. Additionally or alternatively, a pneumatic sensor or several pneumatic sensors can be accommodated in the converter compartment. The support body and the interior space defined by the housing can form several spatially separated chambers in the converter compartment, for example, by intermediate walls, which are particularly pneumatically and/or pressure-tight. It can be preferred that by inserting the support body into the interior space, a receptacle for the electropneumatic converter is formed. Alternatively or additionally, by inserting the support body into the interior space, at least one further receptacle for at least one pneumatic sensor can be formed. For example, by inserting a support body into the interior space of the housing, a converter chamber can be formed in which the electropneumatic converter is or can be accommodated, and a sensor chamber spatially separated from the converter chamber, in which a pneumatic sensor is or can be accommodated. The support body and/or the housing can be manufactured with intermediate walls or equipped with them; for example, the housing can be integrally manufactured with intermediate walls, for example, as an injection-molded part.

According to a preferred embodiment of an inventive manufacturing method, the circuit board is attached to the support body and inserted into the interior space together with the support body. The circuit board can, for example, be attached to the support body with an adhesive, such as glue or solder, and/or with a connecting means, such as a screw. In this way, the support body can serve as an assembly aid for the circuit board. With the help of the support body, an error-free and precise setting of a clearly predetermined insertion position of the circuit board in the interior space of the housing can be easily implemented. By attaching the circuit board to the support body before inserting it into the interior space, the handling of the circuit board for its assembly can be significantly simplified.

In a preferred embodiment of an inventive manufacturing method, at least one, particularly coupled to the circuit board, pneumatic sensor is provided. In an exemplary embodiment, at least one pneumatic sensor is accommodated by the converter compartment. In a converter compartment divided into different chambers, a pneumatic sensor can be arranged together with the electropneumatic converter in the converter compartment. Alternatively or additionally, at least one pneumatic sensor can be arranged in a respective sensor chamber, which is spatially, and optionally pneumatically and/or pressure-tightly, separated from the converter chamber. Several sensor chambers can also be provided in the converter compartment, which are spatially, and optionally pneumatically and/or pressure-tight, separated from each other.

According to a further development of an inventive manufacturing method, at least one sealing element, such as a sealing ring, is arranged on the support body, the circuit board, and/or the housing. In an exemplary embodiment, the at least one sealing element pneumatically and/or pressure-tight separates the converter compartment, particularly a receptacle for the electropneumatic converter and/or at least one further receptacle for the at least one pneumatic sensor, from the electronics compartment. It can be preferred that two or more sealing elements, particularly sealing rings, are provided for pneumatically and/or pressure-tight isolating the converter receptacle. Furthermore, it can be preferred that two or more sealing elements, particularly sealing rings, are provided for pneumatically and/or pressure-tight isolating the at least one sensor receptacle. In an exemplary embodiment, at least one sealing element, such as a sealing ring, particularly per receptacle, is arranged for a sealing contact with, on the one hand, the support body and, on the other hand, the circuit board. Additionally or alternatively, at least one sealing element, such as a sealing ring, particularly per receptacle, can be arranged for a sealing contact with, on the one hand, the support body and, on the other hand, the housing. For example, the support body can be formed with at least one feedthrough for the electropneumatic converter and/or at least one pneumatic sensor, and the at least one sealing element can be arranged at this feedthrough.

According to another embodiment of an inventive method, which can be combined with the previous ones, the circuit board and/or the support body, such as after insertion into the interior space, is at least partially encapsulated, particularly with a potting compound. In an exemplary embodiment, the circuit board and/or the support body is positioned in a predetermined operational position in the interior space of the housing and held in the operational position while applying the encapsulation, particularly making the potting compound. In an exemplary embodiment, the circuit board and/or the support body is first inserted into the interior space, and then the encapsulation, particularly the potting compound, is made. The encapsulation, particularly the potting compound, can be applied at least in the area of the supply electronics and optionally the control and/or regulation electronics. The encapsulation, particularly the potting compound, can optionally be made of a sealing material to act as a sealing element. The circuit board can be protected from contamination and corrosion by the encapsulation.

In an exemplary embodiment, the inventive manufacturing method produces an inventive positioner as described above. The positioner described above may be manufactured according to the inventive manufacturing method.

In the following description of exemplary embodiments with reference to the figures, the same or similar components are provided with the same or similar reference numerals to simplify readability. It should be clear that the directional indications used here are to be understood relative to each other and refer to the illustrations and are not to be understood as limitations regarding the installation situation.

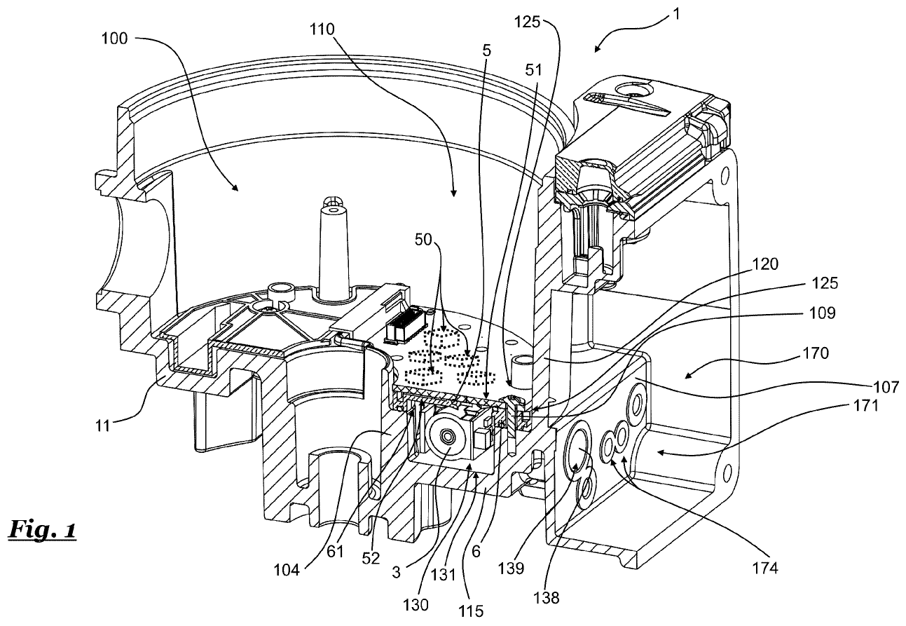

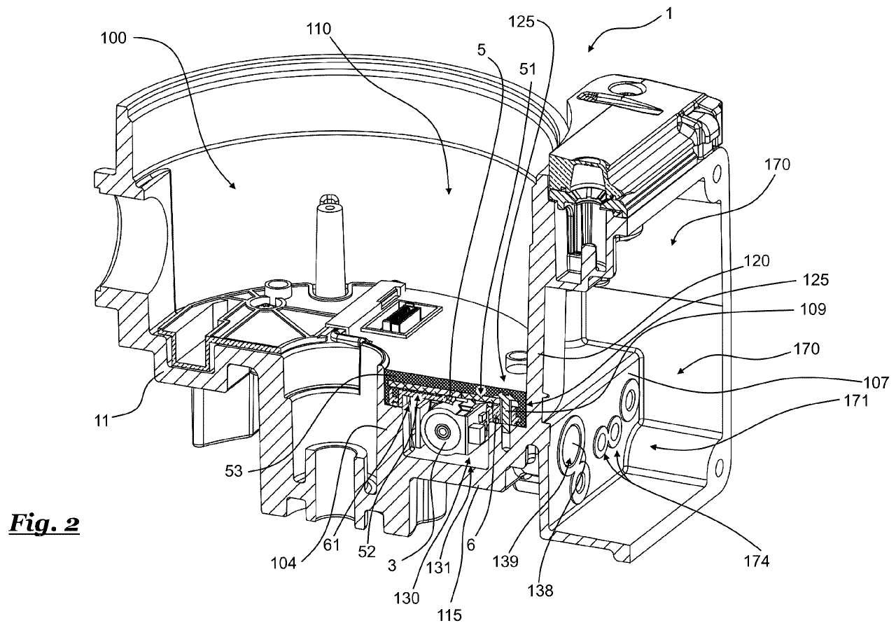

An inventive positioner is generally designated by reference numeral 1. A first embodiment of a positioner 1 is shown in FIG. 1, and another embodiment of a positioner 1 with a potting compound 53 is shown in FIG. 2. The positioner 1 shown in FIG. 1 may include components an electropneumatic converter 3, which may be referred to as a current-to-pressure converter, and a circuit board 5, which may be referred to as a printed circuit board. The circuit board 5 is essentially flat. For insertion into a cylindrical housing 11, the circuit board 5 may have a partial ring or partial circle-shaped cross-section.

The circuit board 5 is equipped with electrical conductor tracks (not shown in detail) and at least one electronic component, which may also be referred to as an electronic component. Electronic components are arranged on the circuit board 5, realizing the supply electronics 50. Other electronic components include, for example, a connector 55 for electrically and/or signal-transmittingly connecting the supply electronics 50 circuit board 5 to a supply unit, a higher-level control unit, or the like, of the positioner 1 (not shown in detail). The electropneumatic converter 3 is connected to the circuit board 5. The electropneumatic converter 3 can be fixedly connected to the circuit board 5, for example, by soldering. Alternatively, the electropneumatic converter 3 can be equipped with a plug, and the circuit board can be equipped with a corresponding socket or plug receptacle 57. The circuit board 5 is also equipped with (not shown in detail) supply electronics for the electropneumatic converter 3. Furthermore, the circuit board can be equipped with control and/or regulation electronics, or parts thereof, for operating the electropneumatic converter 3. In the exemplary embodiments described below, the printed circuit board 5 is also equipped with one or more electropneumatic components or hybrid components.

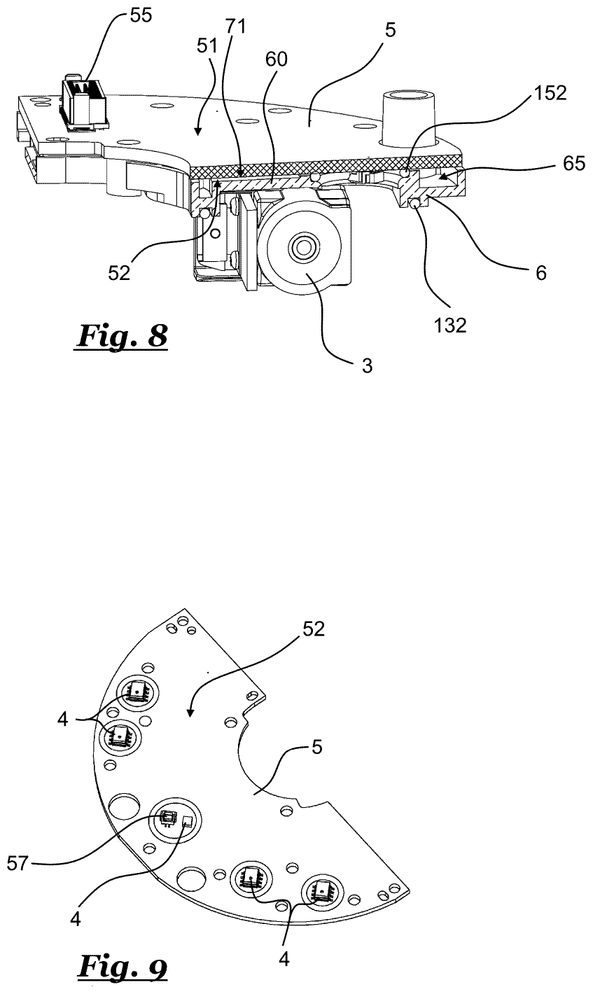

The positioner 1 may comprise a housing 11. The housing surrounds an interior space 100. The circuit board 5 and the electropneumatic converter 3 are arranged inside the housing 11. The circuit board 5 is conveniently arranged inside the housing 11 so that it divides it into, on the one hand, an electronics compartment 110, in which at least one electronic component of the positioner 1 is arranged, and, on the other hand, a converter compartment 130, in which the electropneumatic converter 3 is housed. The circuit board 5 may be a one-piece flat body with a top side 51 and a bottom side 52. The electronics compartment 110 extends from the top side 51, and the converter compartment 130 extends from the bottom side 52. The electronic component is arranged on the top side 51. The electropneumatic converter 3 is arranged on the bottom side 52, as exemplarily shown in FIGS. 7 and 8. Additionally, on the bottom side 52, for example, four pneumatic sensors 4 are arranged next to the electropneumatic converter 3 (FIG. 9).

The circuit board 5 is housed in the interior space 100 in an operational mounting arrangement of the positioner 1. In the operational mounting state of the positioner 1, the interior space 100 is divided into the electronics compartment 110 and the converter compartment 130. The circuit board 5 is fixedly connected to the housing 11, for example, screwed in place. FIG. 2 shows the attachment of the circuit board 5 to the housing 11 by means of a fastening screw 109, which holds the circuit board 5 to the bottom 115 of the housing 11 that bounds the interior space 100. A recess 105 complementary to the circuit board 5 is embedded in the bottom 115 of the housing 10, into which the circuit board 5 is inserted.

As shown, for example, in the embodiments of positioners 1 according to FIGS. 1, 2, or 15, the circuit board 5 can be attached to the housing 11 by means of a support body 6. The support body 6 is arranged in the operational mounting state between the circuit board 5 and the bottom 115 of the housing 11. The support body 6 has a support section 60, which is inserted into the recess 105 together with the circuit board 5. A clearance 125 is provided between the circuit board 5 and the peripheral wall 120 of the housing 11. A cavity or void 65 is formed in sections between the support body 6 and the circuit board 5.

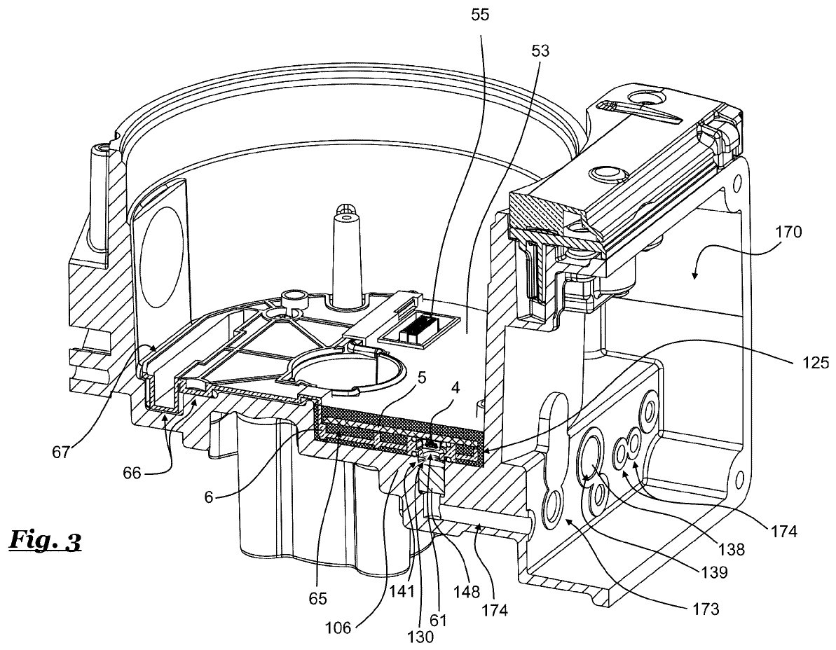

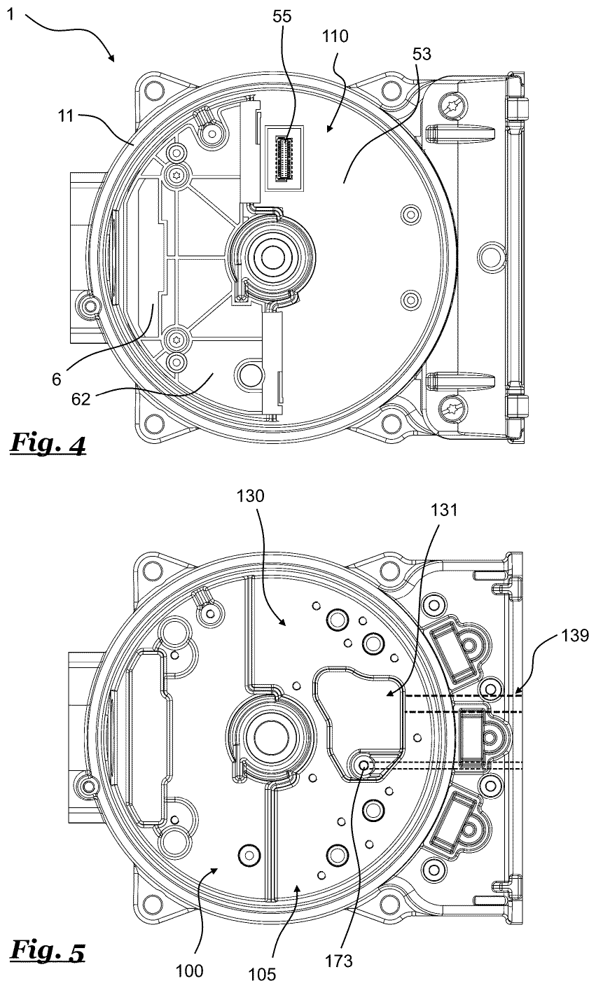

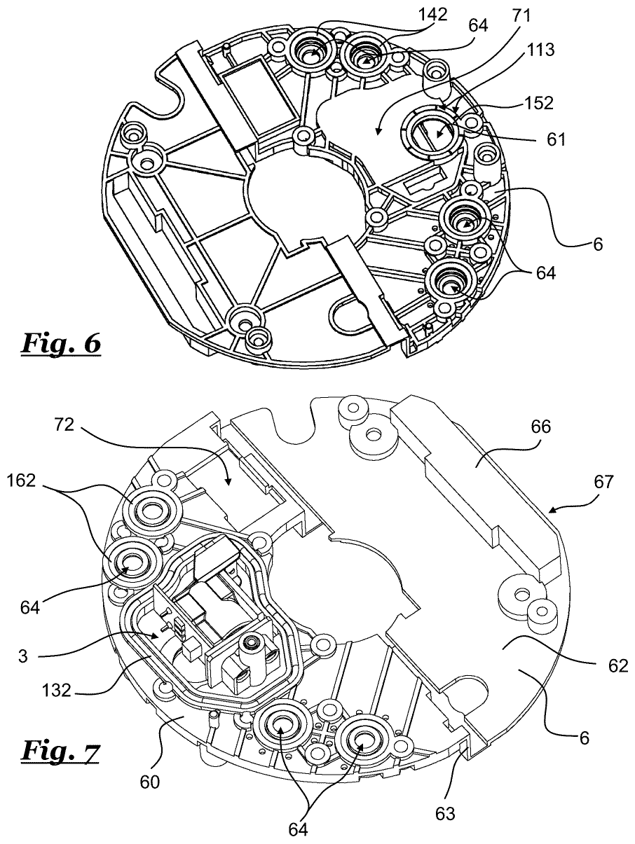

FIG. 6 shows an exemplary embodiment of a support body 6 with a substantially ring-disc shape. The support body 6 can be subdivided into three areas, namely the support section 60, an offset seat section 62, and a step 63 connecting the support section 60 with the seat section 62. The circuit board 5 is arranged in the area of the support section 60. If a fixed connection of the circuit board 5 with the support body 6 is desired, several (not shown in detail) fastening means, such as screws or clips, can be provided. The fastening means can be designed to bias the circuit board 5 against the support body 6. The support body 6 is penetrated by a feedthrough 61 for the electropneumatic converter 3 and further feedthroughs 64 for the pneumatic sensors 4 (see FIG. 3). The feedthroughs 61, 64 are formed in the support section 60.

The seat section 62 can be formed at least in sections form-complementary to the interior space 100 of the housing 10 to define a precise position of the support plate 6 and the circuit board 5, if preassembled thereon. For example, the seat section 62 can be equipped with one or more protrusions 66 and/or recesses adapted to the form of the housing 11. Alternatively or additionally, the support plate 6 can have eccentric mounting aids 67 to cooperate, for example, with the inside of a peripheral wall 120 and/or other wall sections in a housing 11 of substantially cylindrical shape.

FIGS. 2 and 3 show an embodiment of a positioner 1 in which the circuit board 5 is encapsulated with a potting compound 53. The potting compound 53 surrounds the majority of the circuit board 5. The top side 51 of the circuit board 5 is completely covered by the potting compound 53, except for the connector 55, thereby isolating the electrical conductor tracks and electronic components arranged on the surface 51 of the circuit board 5 and protecting them from corrosive influences. The potting compound 53 can be realized, for example, by an air-curing plastic, such as polyurethane. It may be expedient for the circuit board 5 to first be attached to the support body 6 and then inserted together into the interior space 100 and subsequently coated with the potting compound 53. If the circuit board 5 is encapsulated by being potted with potting material in the interior space 100, the cavity 65 and the clearance 125 can be partially or even completely filled with the potting compound 53. The potting compound 53 can realize a form-fitting connection of the circuit board 5 with the housing 11. The potting compound 53 can form a sealing element, which causes or at least contributes to the converter compartment 130 being fluidically, such as pressure-tight, separated from the electronics compartment 110.

In the operational mounting state of the positioner 1, at least one sealing element can be provided for pneumatically and/or pressure-tight separating the electronics compartment 110 from the converter compartment 130. For this purpose, the at least one sealing element is conveniently arranged between the circuit board 5 and the housing 11. Sealing elements can be realized, for example, by sealing rings.

FIG. 6 shows the top side 71 of a support body 6, where a sealing ring 152 is inserted into a receptacle surrounding the feedthrough 61. The other feedthroughs 64 on the top side 71 of the support body 6 are also equipped with respective sealing rings 142. In the operational mounting state, as shown in FIGS. 2 and 3, the support body 6 is in contact with the bottom side 52 of the circuit board 5 in the area of the feedthroughs 61, 64. In the operational mounting state, the sealing rings 152, 142 seal between the support body 6 and the circuit board 5.

FIG. 7 shows the bottom side 72 of the support body 6, which, in the operational mounting state, is in contact with the bottom 115 of the housing 11 in the area of the feedthroughs 61, 64. The electropneumatic converter 3 covers the converter feedthrough to contact the circuit board 5. A sealing ring 132 is inserted into a sealing receptacle form-fitted to the electropneumatic converter 3 around the electropneumatic converter and the associated feedthrough 61. Circular sealing rings 162 are arranged in corresponding receptacles at the other feedthroughs 64. In the operational mounting state, the sealing rings 132, 162 seal between the support body 6 and the housing 11.

The cross-sectional view in FIG. 2 extends through the electropneumatic converter 3 and the sub-area of the converter compartment 130 that forms a receptacle 131 for the electropneumatic converter 3, which can be referred to as the converter receptacle 131.

The cross-sectional view in FIG. 3 extends through a pneumatic sensor 4 in the sub-area of the converter compartment 130 that forms another receptacle 141 for this pneumatic sensor 4, which can also be referred to as the sensor receptacle 141. Optionally, a pneumatic sensor 4 is arranged in the converter receptacle 131 (see FIG. 9).

The converter receptacle 131 shown in FIG. 2 forms a chamber that is pneumatically and/or pressure-tightly separated from the electronics compartment 110. The receptacle 131 is partially bounded by a housing area 104 at the bottom 115 of the housing 11. Opposite the housing 11, the receptacle 131 is bounded by the circuit board 5. Between the circuit board 5 and the housing 11, the feedthrough 61 through the support body 6 bounds the converter receptacle 131. The potting compound 53 and the sealing elements, such as sealing rings 132, 162 (see FIGS. 6, 7), ensure reliable fluid isolation of the converter receptacle 131 in the converter compartment 130 from the electronics compartment 110 as well as from other receptacles 141 in the converter compartment 130.

The sensor receptacle 141 shown in FIG. 3 also forms a chamber that is pneumatically and/or pressure-tight separated from the electronics compartment 110. The sensor receptacle 141 is partially bounded by another housing area 106 at the bottom 115 of the housing 11. The sensor receptacle 141 is also bounded by the circuit board 5 opposite the housing 11 and by the further feedthrough 64 of the support body 6 between the circuit board 5 and the housing 11. The sealing rings 142, 152 (see FIGS. 6, 7) at the further feedthrough 64, possibly together with the potting compound 53, ensure fluid isolation of the sensor receptacles 141 in the converter compartment 130 from the electronics compartment 110 and, conveniently, from other (not shown) receptacles in the converter compartment 130. To detect at least one property, such as pressure, temperature, or the like, of the pneumatic medium at a (not shown in detail) measurement point using the pneumatic sensor 4, a pneumatic line 174 extends from the sensor receptacle 141 to a subsequently described pneumatic compartment 170. Sections of the pneumatic line 174 are fully covered with a sinter filter 148 as an ignition barrier.

Several sub-areas of the positioner, such as the individual chambers forming the converter receptacle 131 or the sensor receptacles 141, the electronics compartment 110, and/or the pneumatic compartment 170, may be designed and arranged to be pressure-tight for mutual pressure differences between the sub-areas of at least 50 mbar, particularly at least 100 mbar, such as at least 1 bar, at least 1 bar, and/or not more than 10 bar, particularly not more than 5 bar, such as not more than 2.5 bar.

Two pneumatic lines, namely a ventilation line 173 and an exhaust channel 139, extend from the converter receptacle 131 to the pneumatic compartment 170, as shown in FIG. 5. The ventilation line 173 or the supply air channel is designed and arranged to fluidly connect the converter chamber 131 and the electropneumatic converter 3 arranged therein with a (not shown in detail) pneumatic source.

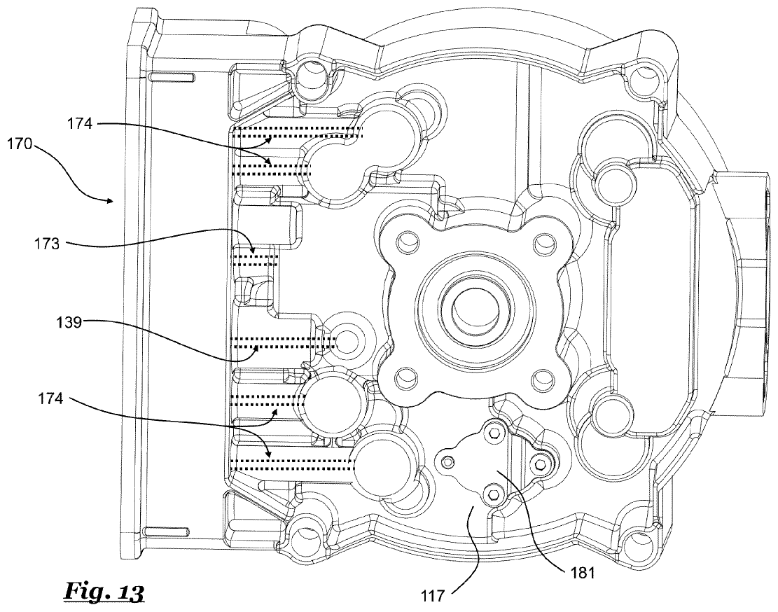

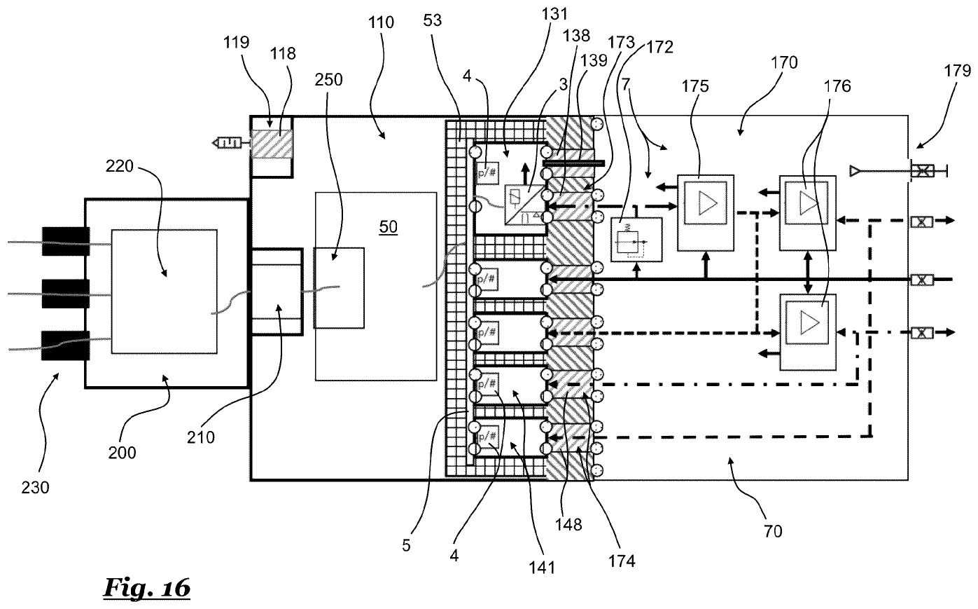

As shown in FIG. 13, the pneumatic lines 139, 173, 174 can extend, for example, substantially parallel, from the converter compartment 130 in the interior space 100 of the housing 11 through its housing wall to the pneumatic compartment 170. The positioner 1 with the pneumatic module 170 and the pneumatic components 7 housed therein is schematically shown in FIG. 16. As shown in FIG. 2, the pneumatic compartment 170 can be formed by a side space of the housing 11. In the pneumatic compartment 170, a pneumatic interface 171 is provided, where pneumatic components 7 or a pneumatic module comprising several pneumatic components 7 can be mounted (not shown in detail). The pneumatic interface 171 can be arranged, for example, on a housing section 107 of the wall section between the converter compartment 130 and the pneumatic compartment 170. The side space and the not shown pneumatic module can be coordinated in such a way that the pneumatic module realizes a form-complementary insert for completely covering the side space.

The pneumatic module can be realized, for example, as a unitary block within which pneumatic channels and several pneumatic components 7, such as pneumatic amplifiers, a preamplifier 175, and a main amplifier 176, flow restrictors, and/or pressure reducers 172, are integrated. The exhaust channel 139 can discharge used pneumatic medium into the pneumatic compartment 170, which is connected to the environment or a collection line for isolated discharge of used pneumatic medium or exhaust gas from the positioner 1, so that the electronic components in the electronics compartment 110 do not come into contact with the pneumatic medium. The pneumatic sensors 4 can be connected to different measurement points regarding the various pneumatic components 7 via pneumatic lines 174.

Conveniently, the electronics compartment 110 can be isolated by hermetically sealing the interior space 100 of the housing 11 with a cover. To prevent an undesirable vacuum from forming in the electronics compartment 110 relative to the ambient pressure of the positioner 1, a ventilation line 119 can penetrate an outer wall 117 of the housing 11. Depending on the application, the ventilation line 119 can be optionally closed or open to the environment using a cover part 180, 181.

The exemplary positioner 1 shown in FIG. 16 has a housing 11 equipped with a pressure-tight “Ex d” cable feedthrough 210, through which the supply electronics 50 and other electronic components arranged in the electronics compartment 110 can be supplied and optionally controlled. For particularly safe configuration, an additional Zener barrier 250 or similar can be provided. Beyond the cable feedthrough 210, such as in a pressure-tight enclosed connection space 200, a connection circuit board 220 can be arranged. The connection circuit board 220 can be connected to external components, such as other components of a process engineering plant, through at least one (here: three) pressure-tight “Ex d” cable feedthroughs 230. FIG. 16 also shows a common ventilation 179 for exhaust air and for discharging pneumatic medium from the pneumatic compartment 170. For critical pneumatic media such as methane, the common ventilation can be connected to a collection line (not shown).

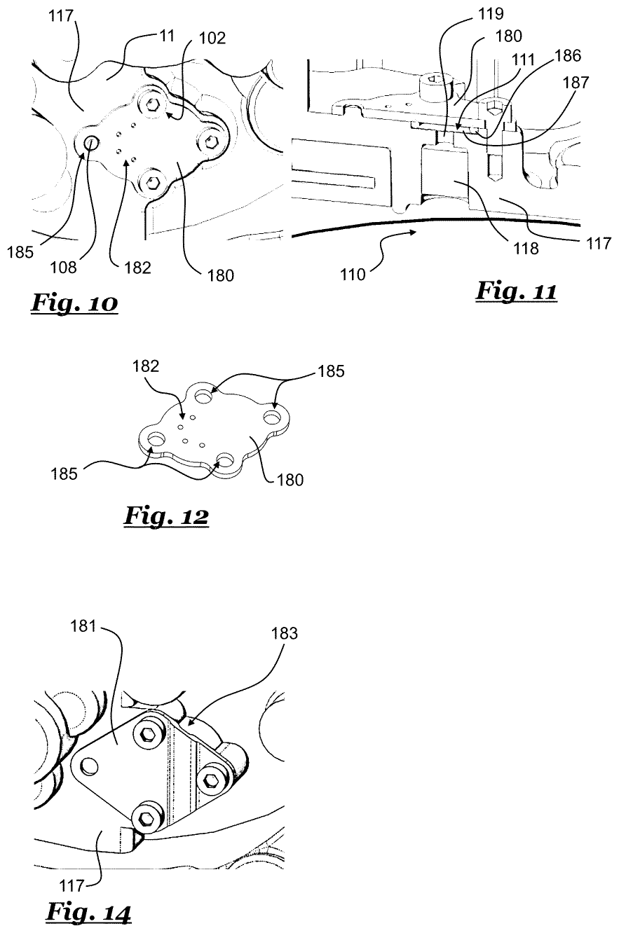

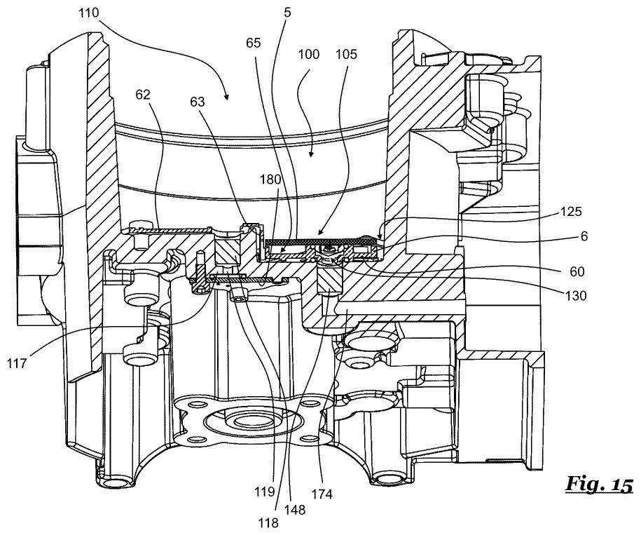

FIGS. 10-12 and 15 show a first variant of the cover part 180, which is penetrated by four through-holes 182. FIGS. 13 and 14 show another variant of the cover part 181 with a groove channel 183. The cover part 180, 181 can be designed as an asymmetrical plate equipped with one or more (here: four) mounting holes 185. To attach it to the housing 11, the outer wall 117 can be equipped with a protrusion 108 to define a mounting position for the cover part 180, 181, with this protrusion 108 being form-complementary to the uniform mounting holes 185. The other mounting holes 185 can be occupied by a screw 102 each to attach the cover part 180, 181. For explosive environments, an ignition barrier 118 can fully cover the ventilation line 119. The outlet 111 of the ventilation line 119 is arranged on the outer side of the outer wall 117, which can be covered with the cover part 180/181. The cover part 180, 181 can be placed in a first, open position in front of the outlet 111, where the ventilation line 119 fluidly communicates with the through-holes 182 or the groove channel 183, so that the electronics compartment 110 is connected to the environment. A membrane 187 can be arranged between the outlet 111 and the cover part 180/181. The membrane 187 is only effective in the open position of the cover part 180/181. The membrane 187 acts as a pressure equalization element. Configurations with a pressure equalization element different from a membrane are also conceivable.

Alternatively, the cover part 180/181, as shown in FIG. 11, can be placed in front of the outlet 111 in such a way that a section of the cover part 180/181, which is free of through-holes, groove channels, and the like, covers the ventilation channel 119. A sealing element 186 surrounding the outlet 111 in a ring shape is arranged between the cover part 180/181 and the outer wall 117. The membrane 187 can be integrally formed with the sealing element 186 as a pressure equalization element with an attached round sealing ring (as a standard part). In the closed position of the cover part 180/181, the ventilation line 119 is sealed by means of the sealing ring 186. In a state as shown in FIG. 11, where the cover part 180/181 covers the outlet 111 to seal the electronics compartment 110, it is alternatively conceivable that the membrane 187 or a pressure equalization element is omitted or not mounted.

The features disclosed in the foregoing description, the figures, and the claims can be significant for the realization of the disclosure in its various embodiments, both individually and in any combination.

### REFERENCE NUMERALS

1 Positioner
3 Electropneumatic converter
4 Pneumatic sensor
5 Circuit board
6 Support body
7 Pneumatic component
11 Housing
50 Supply electronics
51 Top side/surface (circuit board)
52 Bottom side/surface (circuit board)
53 Potting compound
55 Connector
57 Plug receptacle
60 Support section
61 Feedthrough
62 Seat section
63 Step
64 Further feedthrough
65 Cavity
66 Protrusion
67 Mounting aid
70 Pneumatic module
71 Top side (support body)
72 Bottom side (support body)
100 Interior space
102 Screw
104 Housing area
105 Recess
106 Other housing area
107 Housing section
108 Protrusion
109 Fastening screw
110 Electronics compartment
111 Outlet
113 Ventilation channel
115 Bottom
117 Outer wall
118 Sinter filter
119 Ventilation line
120 Peripheral wall
125 Clearance
130 Converter compartment
131,141 Receptacle
132 Sealing ring
138 Sinter filter
139 Exhaust channel
142 Sealing ring
148 Sinter filter
152, 162 Sealing ring
170 Pneumatic compartment
171 Pneumatic interface
172 Pressure reducer
173, 174 Pneumatic line
175 Preamplifier
176 Main amplifier
179 Collection line
180, 181 Cover part
182 Through-hole
183 Groove channel
185 Mounting hole
186 Sealing element
187 Membrane
200 Connection space
210 Cable feedthrough
220 Connection circuit board
230 Cable feedthrough
250 Zener barrier

1. A positioner for a pneumatic actuator for operating a control element in a process engineering plant, the positioner comprising:
a housing defining an interior space;
a support body inserted into the interior space;
an electropneumatic converter; and
a circuit board attached to the support body and comprising supply electronics configured to operate the electropneumatic converter,
wherein the housing and the support body are coordinated to pneumatically subdivide the interior space into an electronics compartment configured to accommodate at least one electrical and/or electronic component and a converter compartment configured to accommodate the electropneumatic converter.

2. The positioner according to claim 1, wherein the electropneumatic converter is arranged on a side of the support body facing away from the electronics compartment and/or the circuit board.

3. The positioner according to claim 1, wherein the converter compartment comprises at least one receptacle in which the electropneumatic converter is arranged, the support body comprising a feedthrough in an area of the at least one receptacle that extends from the housing to the circuit board.

4. The positioner according to claim 1, wherein the converter compartment comprises at least one receptacle in which at least one pneumatic sensor is arranged, the support body comprising a feedthrough in an area of the at least one receptacle that leads to the pneumatic sensor and/or to the circuit board.

5. The positioner according to claim 4, wherein the pneumatic sensor is arranged on a surface of the circuit board facing the converter compartment and/or that the pneumatic sensor is held on the circuit board.

6. The positioner according to claim 1, wherein at least one seal is held on the support body to pneumatically and/or pressure-tightly separate the converter compartment from the electronics compartment.

7. The positioner according to claim 1, wherein:
the housing comprises a peripheral wall and a bottom at least partially surrounded by the peripheral wall with a recess corresponding to the circuit board;
the support body is form-fitted to the interior space; and
a clearance is provided between the support body and the housing in an area of the recess.

8. The positioner according to claim 1, wherein at least one cavity is formed between the circuit board and the support body.

9. The positioner according to claim 8, wherein the support body comprises support sections configured to support the circuit board, at least one cavity being formed between the support sections.

10. The positioner according to claim 1, wherein the circuit board is at least partially encapsulated.

11. The positioner according to claim 1, wherein the support body is at least partially encapsulated.

12. A method for manufacturing a positioner for a pneumatic actuator for operating a control element in a process engineering plant, the method comprising:
providing a circuit board with supply electronics and at least one electropneumatic converter;
providing a housing with an interior space and a support body insertable into the housing;
inserting the circuit board into the interior space; and
attaching the circuit board to the housing by the support body,
wherein the interior space is pneumatically subdivided by the support body into an electronics compartment that accommodates the supply electronics and a converter compartment that accommodates the electropneumatic converter.

13. The method according to claim 12, wherein the circuit board is attached to the support body, and the circuit board is inserted into the interior space together with the support body.

14. The method according to claim 12, wherein the circuit board and/or the support body, is at least partially encapsulated.

15. The positioner according to claim 6, wherein the seal is arranged: between the support body and the circuit board; and/or between the support body and the housing.
